(19) United States
(12) Patent Application Publication
(10) Pub. No.: US 2024/0118445 A1
(43) Pub. Date: Apr. 11, 2024

(54) SYSTEM AND METHOD FOR INTER-WELLBORE MONITORING

(71) Applicant: SAUDI ARABIAN OIL COMPANY, Dhahran (SA)

(72) Inventors: Ali Aldawood, Safwa (SA); Andrey Bakulin, Dhahran (SA)

(73) Assignee: SAUDI ARABIAN OIL COMPANY, Dhahran (SA)

(21) Appl. No.: 17/935,475

(22) Filed: Sep. 26, 2022

(51) Int. Cl. G01V 1/50; E21B 43/00; G01V 1/22

(52) U.S. Cl. CPC G01V 1/50; E21B 43/00; G01V 1/226; E21B 2200/20; G01V 2210/66

(57) ABSTRACT

Systems and methods are disclosed. The method includes obtaining a first seismic dataset generated by a passive seismic source at a first epoch for an inter-wellbore region of interest lying between a first wellbore and a second wellbore. The first seismic dataset includes a first plurality of seismic traces recorded by a first optical fiber in the first wellbore and a second plurality of seismic traces recorded by a second optical fiber in the second wellbore. The method further includes determining a first virtual seismic dataset by applying seismic interferometry to the first seismic dataset. The method still further includes determining a first seismic velocity model for the inter-wellbore region of interest by applying seismic inversion to the first virtual seismic dataset.

### BACKGROUND

In the oil and gas and carbon dioxide sequestration industries, it may be useful to monitor an inter-wellbore region of interest periodically or continuously. Monitoring may be performed as wells are being drilled and/or as hydrocarbons are being produced from the wells. Monitoring may provide insight into how drilling and/or production affects subterranean features and fluid motion within the inter-wellbore region of interest. Further, monitoring may be used, at least in part, to determine completion programs and/or recovery programs, such as fluid injection programs.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes obtaining a first seismic dataset generated by a passive seismic source at a first epoch for an inter-wellbore region of interest lying between a first wellbore and a second wellbore. The first seismic dataset includes a first plurality of seismic traces recorded by a first optical fiber in the first wellbore and a second plurality of seismic traces recorded by a second optical fiber in the second wellbore. The method further includes determining a first virtual seismic dataset by applying seismic interferometry to the first seismic dataset. The method still further includes determining a first seismic velocity model for the inter-wellbore region of interest by applying seismic inversion to the first virtual seismic dataset.

In general, in one aspect, embodiments relate to a non-transitory computer-readable memory having computer-executable instructions stored thereon that are executable by a processor. The computer-executable instructions cause the processor to perform steps that include receiving a first seismic dataset generated by a passive seismic source at a first epoch for an inter-wellbore region of interest lying between a first wellbore and a second wellbore. The first seismic dataset includes a first plurality of seismic traces recorded by a first optical fiber in the first wellbore and a second plurality of seismic traces recorded by a second optical fiber in the second wellbore. The steps further include determining a first virtual seismic dataset by applying seismic interferometry to the first seismic dataset. The steps still further include determining a first seismic velocity model for the inter-wellbore region of interest by applying seismic inversion to the first virtual seismic dataset.

In general, in one aspect, embodiments relate to a system. The system includes a distributed acoustic sensing (DAS) system to record a first seismic dataset for an inter-wellbore region of interest lying between a first wellbore and a second wellbore. The DAS system includes a first optical fiber in the first wellbore and a second optical fiber in the second wellbore. The system further includes a seismic processing system configured to receive the first seismic dataset generated by a passive seismic source at a first epoch. The first seismic dataset includes a first plurality of seismic traces recorded by the first optical fiber and a second plurality of seismic traces recorded by the second optical fiber. The seismic processing system is further configured to determine a first virtual seismic dataset by applying seismic interferometry to the first seismic dataset. The seismic processing system is still further configured to determine a first seismic velocity model for the inter-wellbore region of interest by applying seismic inversion to the first virtual seismic dataset.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a seismic survey in accordance with one or more embodiments.

FIG. 2 illustrates a distributed acoustic sensing system in accordance with one or more embodiments.

FIG. 3 depicts traveltime inversion in accordance with one or more embodiments.

FIG. 4 shows a first workflow in accordance with one or more embodiments.

FIG. 5 shows a second workflow in accordance with one or more embodiments.

FIG. 6 illustrates a computer system in accordance with one or more embodiments.

FIG. 7 illustrates a fluid pumping system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a passive seismic source” includes reference to one or more of such sources.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

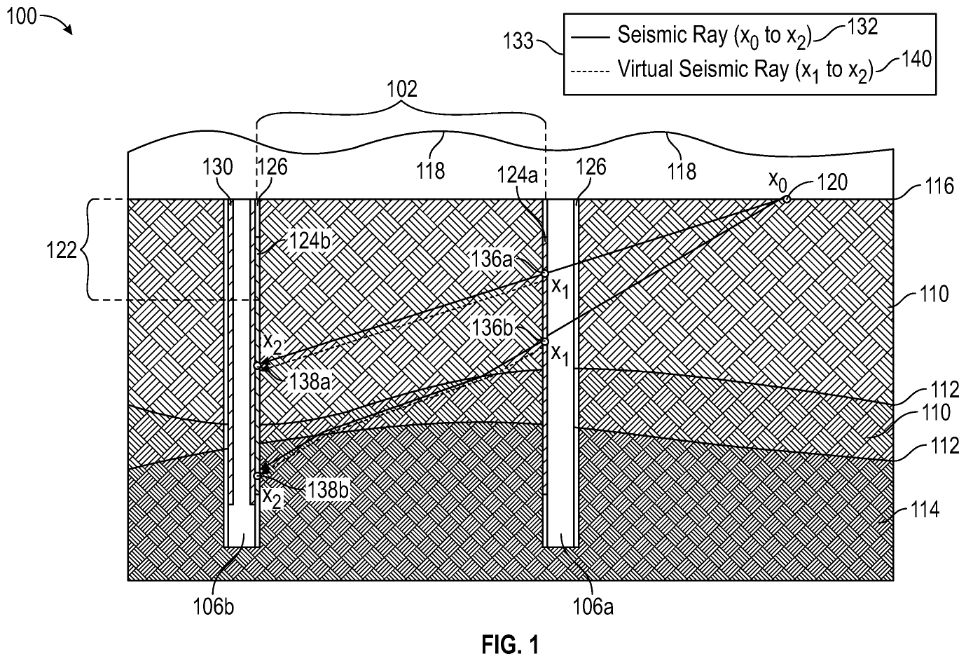

In the following description of FIGS. 1-7, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Periodic or continuous inter-wellbore monitoring may allow an inter-wellbore region of interest to be characterized as it changes. Subterranean features and fluid motion changes within the inter-wellbore region of interest may occur due to drilling and/or production operations. Systems and methods are disclosed to monitor an inter-wellbore region of interest periodically or continuously. Systems include passive seismic sources and optical fibers used as seismic receivers. Methods include seismic interferometry and seismic inversion.

FIG. 1 depicts a seismic survey (100) of an inter-wellbore region of interest (102) in accordance with one or more embodiments. The seismic survey (100) may be a vertical seismic profiling (VSP) survey. The inter-wellbore region of interest (102) lies between a first wellbore (106a) and a second wellbore (106b). The wellbores (106a, b) may traverse rock layers (110) and geological discontinuities (112) to ultimately penetrate a hydrocarbon reservoir (114). Rock layers (110) and geological discontinuities (112) may be considered subterranean features. The inter-wellbore region of interest (102) may lie beneath a seabed (116).

The seismic survey (100) relies on a seismic source to generate seismic waves. A controlled seismic source may be challenging and expensive to deploy, activate, and recover from either wellbore (106a, b) (i.e., downhole). An alternative to a controlled seismic source downhole is a passive seismic source. The passive seismic source may be defined as an earth tremor causes by natural phenomena or by an anthropogenic source, such as road noise or pump noise. The passive seismic source may be unconnected to the seismic survey. In some embodiments, the passive seismic source may be sea waves (118), as depicted in FIG. 1, or other water waves. The frequency bandwidth of the seismic waves generated by sea waves (118) may be between 0.1 Hertz and 8.0 Hertz. However, the passive seismic source may include frequencies above 8.0 Hertz, such as those generated by human activity. Hereinafter, reference to a seismic source assumes the seismic source is a passive seismic source.

In some embodiments, the passive seismic source may be modeled as a continuum of point sources. For simplicity, FIG. 1 shows one passive seismic point source (120) along the seabed (116) generated by sea waves (118). Each passive seismic point source (120) may propagate radiated seismic waves into the inter-wellbore region of interest (102). FIG. 1 displays seismic rays as shown by the key (133) to illustrate the direction of propagation of the radiated seismic waves. Some radiated seismic waves may propagate through the inter-wellbore region of interest (102) and be detected in one or both wellbores (106a, b). Further, some radiated seismic waves may reflect and/or refract at geological discontinuities (112).

The radiated, refracted, and/or reflected seismic waves may be detected and recorded by seismic receivers. Hereinafter, radiated seismic waves, refracted seismic waves, and reflected seismic waves are collectively referred to as simply “seismic waves.” Traditionally, seismic receivers detect seismic waves at discrete depths (122) along a wellbore (106a, b). However, discrete-depth seismic receivers may be cumbersome to deploy and recover from wellbores (106a, b) downhole. Further, discrete-depth seismic receivers may not detect seismic waves between the discrete depths. Further still, discrete-depth seismic receivers may be inconvenient and expensive to deploy during drilling of the wellbores (106a, b) or during production of the hydrocarbon reservoir (114). As such, changes in the subterranean features and fluid motion within the inter-wellbore region of interest (102) over time may be difficult to access.

Permanent nearly continuous-depth seismic receivers, such as optical fibers, may remove these challenges. Hereinafter, reference to a seismic receiver assumes the seismic receiver is a portion of an optical fiber. FIG. 1 illustrates a first optical fiber (124a) permanently disposed in the annulus (126) of the first wellbore (106a) and a second optical fiber (124b) permanently disposed in the annulus (126) of the second wellbore (106b). In some embodiments, the optical fibers (124a, b) may be cemented behind casing strings (130) and/or casing liners. In other embodiments, the optical fibers (124a, b) may be attached to production tubing or suspended freely in the annulus (126) between production tubing and casing string (130), casing liners, or the wall of the wellbore (106a, b).

Each optical fiber (124a, b) may be made up of a flexible, glass core surrounded by cladding. When light, such as a laser beam, is emitted into the core of each optical fiber (124a, b), the light totally internally reflects at the core boundaries to travel along the length of each optical fiber (124a, b). One or more optical fibers (124a, b) may be referred to as a fiber optic cable. Further, one or more optical fibers (124a, b) may be a part of a distributed acoustic sensing (DAS) system.

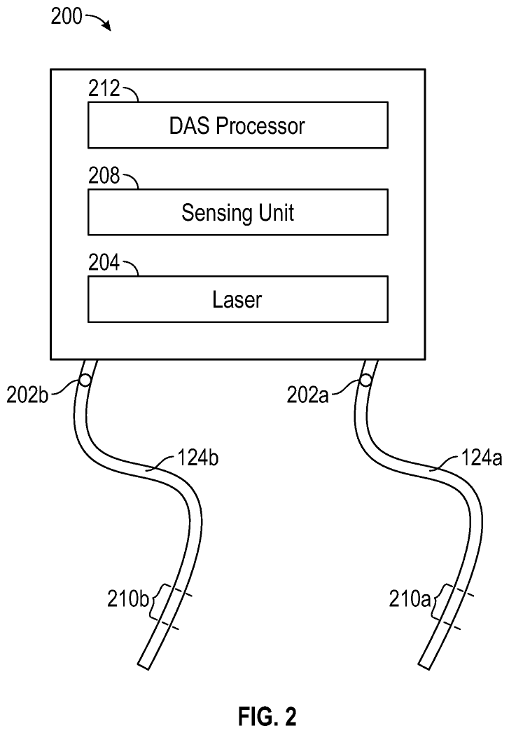

FIG. 2 depicts a DAS system (200) in accordance with one or more embodiments. In a DAS system (200), a pulse of light (202a, b) from a laser (204) is emitted into each optical fiber (124a, b). As each pulse of light (202a, b) (hereinafter also “pulse”) travels along the length of each optical fiber (124a, b), portions of each pulse (202a, b) backscatter from impurities in the glass core in the direction opposite to each emitted pulse (202a, b). Backscatter is detected by a sensing unit (208) over time and recorded. Each location along the length of each optical fiber (124a, b) where backscatter occurred is determined based on when the backscatter is detected by the sensing unit (208) and by assuming the velocity of light in glass. For each local section (210a, b) or “gauge” of each optical fiber (124a, b), the length of each optical fiber (124a, b) and the backscatter is altered when each local section (210a, b) is strained by incident seismic waves. The altered backscatter may be used to determine the length changes in each local section (210a, b) of each optical fiber (124a, b). Length changes in each local section (210a, b) of each optical fiber (124a, b) may present as strain, where strain is the change in the length of each local section (210a, b) relative to the original length of the local section (210a, b). Once each pulse of light (202a, b) returns to the sensing unit (208), another pulse of light (202a, b) may be emitted and strain re-determined.

The seismic waves detected by each optical fiber (124a, b) may be recorded and processed using a DAS processor (212), also known as an “optical interrogator,” to determine a time series representing strain at a sequence of discrete times t. Each time series is referred to as a “seismic trace.” A seismic trace is recorded for each local section (210a, b) or gauge along the length of each optical fiber (124a, b). Thus, each optical fiber (124a, b) may act as a nearly continuous array of seismic receivers.

The first optical fiber (124a) and second optical fiber (124b) emit successive pulses of light (202a, b) typically on the order of milliseconds over a discrete time period or epoch for a single seismic survey (100). In some embodiments, an epoch may be minutes, hours, or days. Each seismic survey (100) may result in the recording of both unique and redundant seismic traces where the detected seismic waves span within and beyond the inter-wellbore region of interest (102). Hereinafter, the seismic traces detected by the two or more optical fibers (124a, b) within the inter-wellbore region of interest (102) for one epoch is denoted a “seismic dataset.” Hereinafter, the seismic dataset for an m-th epoch is an “m-th seismic dataset.”

A seismic survey (100) that uses a passive seismic source and optical fibers (124a, b) as seismic receivers may be performed for numerous epochs during the lifecycle of the wellbores (106a, b) to monitor the inter-wellbore region of interest (102). Typically, the epochs may be separated from each other by months or years. Monitoring may be used to access velocity changes in the inter-wellbore region of interest (102) during drilling and/or production. Velocity changes may provide insight into the migration of subterranean features and fluids caused by drilling and/or production to inform completion and/or recovery programs.

Seismic interferometry, also known as the virtual source method, may be used to modify the seismic dataset. Seismic interferometry (hereinafter also “SI”) is a method that may determine a “virtual seismic dataset” using the seismic dataset. In some embodiments, “virtual seismic traces” within the virtual seismic dataset may be determined from virtual seismic waves emitted from a virtual seismic source and recorded by a seismic receiver. In some embodiments, the location of the virtual seismic source may be the location of the first optical fiber (124a) deployed in the first wellbore (106a). Further to some embodiments, the location of the seismic receiver may be the location of the second optical fiber (124b) deployed in the second wellbore (106b). The term “virtual” is then used to denote that the virtual seismic source is not physically deployed in the first wellbore (106a). SI may use the mathematical operation of cross-correlation to determine the virtual seismic dataset. However, convolution, in part, may alternatively be used.

Returning to FIG. 1, FIG. 1 illustrates a simplified example of SI in accordance with one or more embodiments. FIG. 1 shows the sea waves (118) modeled as one passive seismic point source (120) at x₀ among a continuum of passive seismic point sources (not shown). The passive seismic point source (120) may propagate a radiated seismic wave in the direction indicated by the seismic ray (132) as shown by the key (133). The seismic wave may be detected by the first optical fiber (124a) in the first wellbore (106a) at x₁ and recorded as a first seismic trace s₁. The seismic wave may also be detected by the second optical fiber (124b) at x₂ in the second wellbore (106b) and recorded as a second seismic trace s₂. Cross-correlation of the first seismic trace s₁ and the second seismic trace s₂ produces a virtual seismic trace sᵥ where:

sᵥ(τ)=∫_{-∞}^{∞}s₁(t)s₂(τ+t)dt, Equation (1)

where τ is the time lag between s₁ and s₂. The virtual seismic trace sᵥ may be thought of as a virtual seismic wave propagating from a virtual point source (136a, b) on the first optical fiber (124a) located at x₁ to a point receiver (138a, b) on the second optical fiber (124b) located at x₂ as shown by the virtual seismic ray (140) in FIG. 1. Note that while the seismic ray (132) and the virtual seismic ray (140) are shown offset relative to one another for illustration, the virtual seismic ray (140) may actually overlap the seismic ray (132) within the inter-wellbore region of interest (102). Here, cross-correlation may be a measure of phase lag between the first seismic trace s₁ and the second seismic trace s₂. In some embodiments, numerous first seismic traces and second seismic traces may be cross-correlated to determine virtual seismic traces.

In other embodiments, SI may use Green's function in the space-frequency domain to accommodate cross-correlating a large number of seismic traces. Green's function may be written as:

$$2 \{ \hat{G} ( {x}_{2} , {x}_{1} , ω ) \} \approx \frac{2}{ρ c} {∮}_{\partial 𝔻} {\hat{G}}^{*} ( {x}_{1} , {x}_{0} , ω ) \hat{G} ( {x}_{2} , {x}_{0} , ω ) {d}^{2} {x}_{0} , \qquad Equation ( 2 )$$

where [symbol] { } denotes the real part of the function within braces, Ĝ is Green's function, Ĝ* is the complex conjugate of Green's function, x₀ is the three-dimensional (3D) position of a passive seismic point source (120), x₁ is the 3D position of a local section (210a) on the first optical fiber (124a) and a virtual point source (136a, b), x₂ is the 3D position of a local section (210b) on the second optical fiber (124b) and a point receiver (138a, b), and ω is angular frequency. In practice, ∂ [symbol] may be the open line created by each optical fiber (124a, b). Multiplication of Ĝ* and Ĝ on the right side of Equation (2) corresponds to cross-correlation in the time domain for all first seismic traces and all second seismic traces recorded along ∂ [symbol] .

Applying SI using Equation (2) to the seismic dataset determines a virtual seismic dataset. In FIG. 1, local sections (210a) of the first optical fiber (124a) become the virtual point sources (136a, b) following SI. In other embodiments, local sections (210b) of the second optical fiber (124b) or both optical fibers (124a, b) may be the virtual point sources (136a, b).

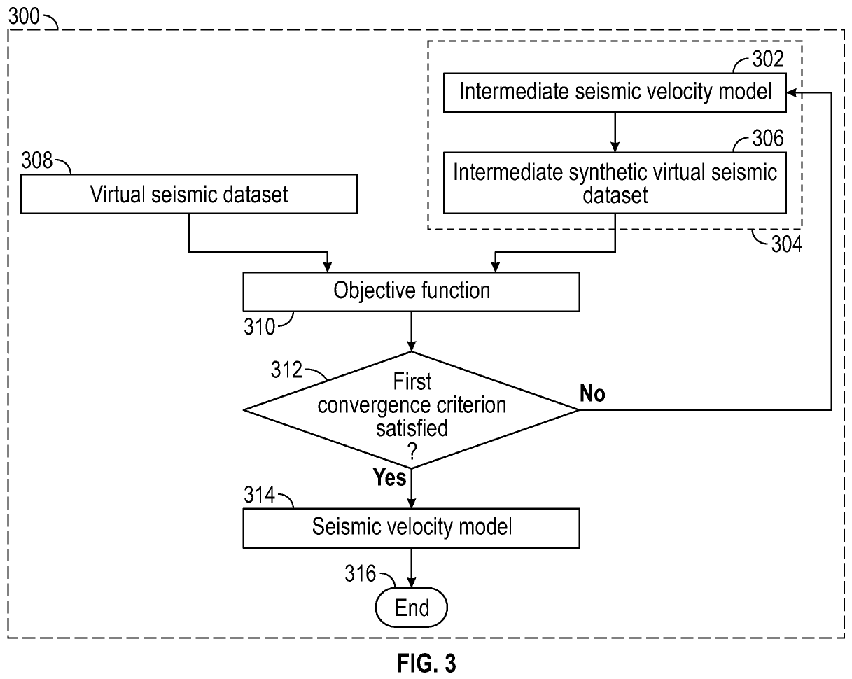

Seismic inversion may be applied to the virtual seismic dataset to determine a seismic velocity model for the inter-wellbore region of interest (102). Seismic inversion may be seismic tomography, alternatively known as traveltime inversion. Traveltime inversion may use only the traveltimes of the virtual seismic traces within the virtual seismic dataset to determine the seismic velocity model. Other types of seismic inversion may use attributes in addition to or other than traveltimes of the virtual seismic traces to determine a seismic velocity model and/or other geophysical model. For example, full waveform inversion may use all attributes of the virtual seismic traces (i.e., traveltime, amplitude, frequency, and phase) to determine a geophysical model. Traveltime inversion (300) is depicted in FIG. 3 in accordance with one or more embodiments.

Traveltime inversion (300) may be an iterative process that begins with initializing an intermediate seismic velocity model (302). The initial intermediate seismic velocity model (302) may be based, at least in part, on seismic surveys (100) and well logs as well as rock core samples collected from the wellbores (106a, b) or the inter-wellbore region of interest (102). Alternatively, the initial intermediate seismic velocity model (302) may be assumed to be a homogeneous velocity throughout the inter-wellbore region of interest (102).

Forward modeling (304) may be applied to the intermediate seismic velocity model (302) to determine an intermediate synthetic virtual seismic dataset (306). In some embodiments, forward modeling (304) may be the process of solving or approximating physics-based equations that govern the relationship between the intermediate seismic velocity model (302) and the intermediate synthetic virtual seismic dataset (306). For example, forward modeling (304) may be the process of solving the elastic wave equation to simulate how virtual seismic waves propagate through the inter-wellbore region of interest (102) based on the intermediate seismic velocity model (302). In other embodiments, forward modeling (304) may be a ray tracing process that uses the intermediate seismic velocity model (302) to estimate the traveltimes of virtual seismic waves on a grid-by-grid basis that represents the inter-wellbore region of interest (102). The intermediate synthetic virtual seismic dataset (306) determined from forward modeling (304) may look similar to the virtual seismic dataset (308) determined from SI.

In traveltime inversion (300), the intermediate synthetic virtual seismic dataset (306) and the virtual seismic dataset (308) are compared using an objective function (310). A common objective function (310) includes a least-squares norm. An extremum of the objective function (310) may be found by iteratively perturbing the intermediate seismic velocity model (302), re-determining the intermediate synthetic virtual seismic dataset (306), re-determining a value of the objective function (310), and comparing the value of the objective function (310) to a first convergence criterion (312). The extremum may be a minimum or a maximum of the objective function (310). Once the value of the objective function (310) satisfies the first convergence criterion (312), the value of the objective function (310) is considered an extremum, the intermediate seismic velocity model (302) is assigned to be the seismic velocity model (314) that adequately represents the inter-wellbore region of interest (102), and the iterative process of traveltime inversion (300) ends (316). If the value of the objective function (310) does not satisfy the first convergence criterion (312), the intermediate seismic velocity model (302) is again perturbed. Perturbation may be defined as adjusting or deviating velocities within the intermediate seismic velocity model (302) slightly relative to the intermediate seismic velocity model (302) from the previous iteration. Perturbation for each iteration continues until the first convergence criterion (312) is satisfied. The intermediate seismic velocity model (302) may be perturbed such that the intermediate synthetic virtual seismic dataset (306) more closely resembles the virtual seismic dataset (308) relative to the intermediate synthetic virtual seismic dataset (306) in the previous iteration.

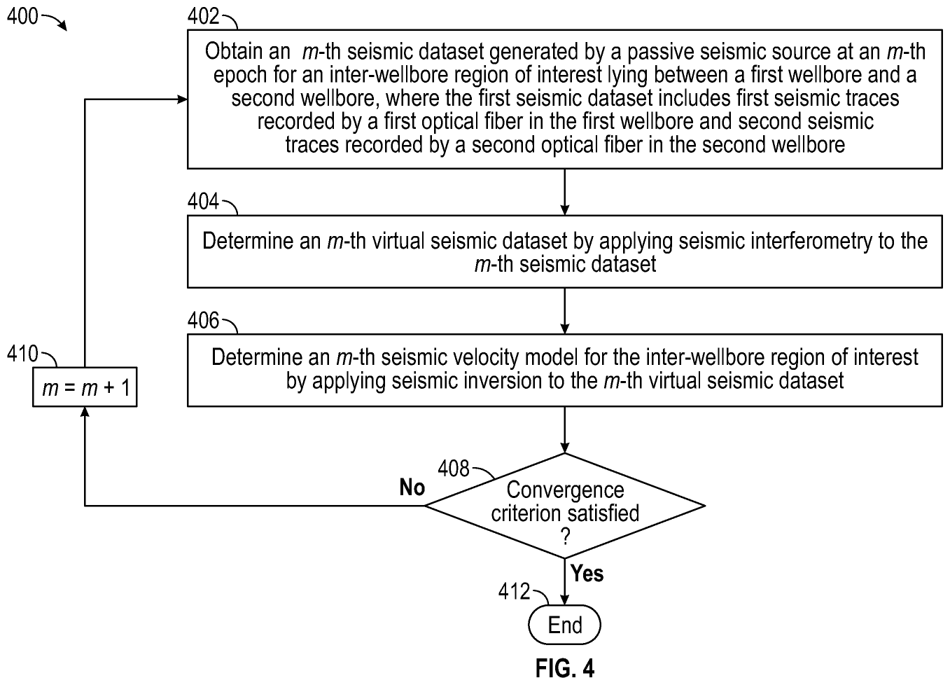

FIG. 4 describes a first method (400) in accordance with one or more embodiments. In the following steps, m denotes an epoch count that may begin at m=1. In step 402, an m-th seismic dataset is obtained for an m-th epoch for an inter-wellbore region of interest (102). The seismic survey (100) used to determine the m-th seismic dataset includes a passive seismic source. The passive seismic source may be water waves, such as sea waves (118). The frequency bandwidth of the passive seismic source may be 0.1 Hertz to 8.0 Hertz. However, the passive seismic source may include frequencies above 8.0 Hertz due secondary passive sources, such as those caused by human activity. In some embodiments, the seismic survey (100) further includes a first optical fiber (124a) within a first wellbore (106a) and a second optical fiber (124b) within a second wellbore (106b). The optical fibers (124a, b) are the nearly depth-continuous seismic receivers. In other embodiments, one or more optical fibers (124a, b) may be permanently disposed downhole for each of two or more wellbores (106a, b).

In step 404, an m-th virtual seismic dataset is determined by applying seismic interferometry to the m-th seismic dataset. SI may be applied to the m-th seismic dataset using cross-correlation as described in Equation (2).

In step 406, an m-th seismic velocity model is determined by applying seismic inversion to the m-th virtual seismic dataset. Specifically, seismic inversion may be traveltime inversion (300) where the traveltimes from the virtual seismic traces of the m-th virtual seismic dataset are used to determine the m-th seismic velocity model.

The first method (400) may be repeated for numerous epochs. The number of epochs performed may be based on satisfying a convergence criterion (408). In some embodiments, the convergence criterion may be a pre-determined number of epochs. In other embodiments, the convergence criterion may be based on when drilling, completion, and/or production of one or more of the wellbores (106a, b) concludes. If the convergence criterion is not satisfied, the epoch number increases by one (410) and steps 402 through 408 are repeated. The first method (400) ends (412) when the convergence criterion is satisfied.

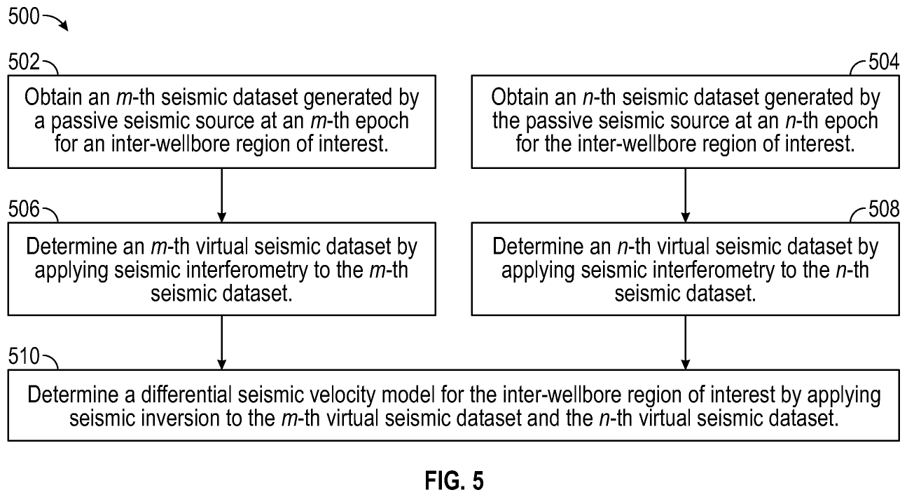

FIG. 5 depicts a second method (500) in accordance with one or more embodiments. In step 502, an m-th seismic dataset generated by a passive seismic source at an m-th epoch for an inter-wellbore region of interest (102) is obtained. In step 504, an n-th seismic dataset generated by a passive seismic source at an n-th epoch for the inter-wellbore region of interest (102) is obtained. In some embodiments, m<n, where the m-th epoch and the n-th epoch are separated by months or years. Steps 502 and 504 may be similar to step 402 described in FIG. 4.

In step 506, an m-th virtual seismic dataset is determined by applying seismic interferometry to the m-th seismic dataset. In step 508, an n-th virtual seismic dataset is determined by applying seismic interferometry to the n-th seismic dataset. Steps 506 and 508 may be similar to step 404 described in FIG. 4.

In step 510, a differential seismic velocity model is determined by applying seismic inversion to the m-th virtual seismic dataset and the n-th virtual seismic dataset. The differential seismic velocity model may be used to assess changes in subterranean features and fluid motion within the inter-wellbore region of interest (102) caused by drilling and/or production. The changes in subterranean features and fluid motion may be used to predict changes for later epochs. Further, the changes in subterranean features and fluid motion may be used to inform completion and/or recovery programs.

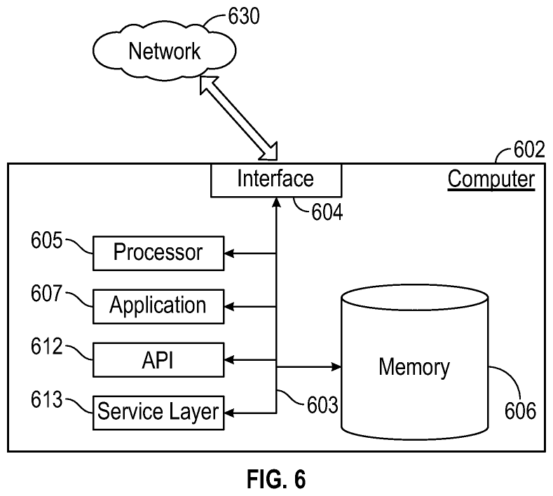

FIG. 6 depicts a block diagram of a computer system (602) (hereinafter also “computer”) in accordance with one or more embodiments. One computer system (602) may be specifically configured for seismic processing and denoted a seismic processing system. Another computer system (602) may be specifically configured for seismic interpretation and denoted a seismic interpretation workstation. Hereinafter, a computer system (602) generically denotes a seismic processing system or a seismic interpretation workstation. Each computer system (602) is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, each computer system (602) may include an input device, such as a keypad, keyboard, touch screen, or other device that can accept user information, and an output device that displays information, including digital data, visual or audio information (or a combination of both), or a graphical user interface. Specifically, a seismic interpretation workstation may include a robust graphics card for the detailed rendering of a seismic velocity model that may be displayed and manipulated in a virtual reality system using 3D goggles, a mouse, or a wand.

Each computer system (602) can serve in a role as a client, network component, server, database, or any other component (or a combination of roles) of a computer system (602) as required for seismic processing and seismic interpretation. Each illustrated computer system (602) is communicably coupled with a network (630). For example, a seismic processing system and a seismic interpretation workstation may be communicably coupled using a network (630). In some implementations, one or more components of each computer system (602) may be configured to operate within environments, including cloud-computing-based, local, global, or other environment (or a combination of environments).

At a high level, each computer system (602) is an electronic computing device operable to receive, transmit, process, store, and/or manage data and information associated with seismic processing and seismic interpretation. According to some implementations, each computer system (602) may also include or be communicably coupled with an application server, e-mail server, web server, caching server, streaming data server, business intelligence (BI) server, or other server (or a combination of servers).

Because seismic processing and seismic interpretation may not be sequential, each computer system (602) can receive requests over network (630) from the other computer system (602) or another client application and respond to the received requests by processing the requests appropriately. For example, a discontinuity interpreted as the manifestation of a subterranean feature within a seismic velocity model may be further processed to improve the focus of the subterranean feature. In addition, requests may also be sent to each computer system (602) from internal users (for example, from a command console or by other appropriate access method), external or third-parties, other automated applications, as well as any other appropriate entities, individuals, systems, or computer systems (602).

Each of the components of the computer system (602) can communicate using a system bus (603). In some implementations, any or all of the components of each computer system (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to each computer system (602) or other components (whether or not illustrated) that are communicably coupled to each computer system (602). The functionality of each computer system (602) may be accessible for all service consumers using this service layer (613). Software services, such as those provided by the service layer (613), provide reusable, defined business functionalities through a defined interface. For example, the interface may be software written in JAVA, C++, or other suitable language providing data in extensible markup language (XML) format or another suitable format. While illustrated as an integrated component of each computer system (602), alternative implementations may illustrate the API (612) or the service layer (613) as stand-alone components in relation to other components of each computer system (602) or other components (whether or not illustrated) that are communicably coupled to each computer system (602). Moreover, any or all parts of the API (612) or the service layer (613) may be implemented as child or sub-modules of another software module, enterprise application, or hardware module without departing from the scope of this disclosure.

Each computer system (602) includes an interface (604). Although illustrated as a single interface (604) in FIG. 6, two or more interfaces (604) may be used according to particular needs, desires, or particular implementations of each computer system (602). The interface (604) is used by each computer system (602) for communicating with other systems in a distributed environment that are connected to the network (630). Generally, the interface (604) includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of each illustrated computer (602).

Each computer system (602) includes at least one computer processor (605) (hereinafter also “processor”). A DAS processor (212) may be similar to a computer processor (605). Generally, a computer processor (605) executes any instructions, algorithms, methods, functions, processes, flows, and procedures as described in the instant disclosure. A computer processor (605) may be a central processing unit (CPU) and/or a graphics processing unit (GPU). A seismic dataset and virtual seismic dataset may be hundreds of terabytes in size. To efficiently process seismic datasets and virtual seismic datasets, a seismic processing system may consist of an array of CPUs with one or more subarrays of GPUs attached to each CPU.

Each computer system (602) also includes a memory (606) that holds data for each computer system (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of each computer system (602) and the described functionality. While memory (606) is illustrated as an integral component of each computer system (602), in alternative implementations, memory (606) can be external to each computer system (602). For example, tape readers or high-capacity hard drives that store seismic datasets may be externally connected to a seismic processing system.

The application (607) is an algorithmic software engine providing functionality according to particular needs, desires, or particular implementations of each computer system (602), particularly with respect to functionality described in this disclosure. For example, application (607) can serve as one or more components, modules, applications, etc. Further, although illustrated as a single application (607), the application (607) may be implemented as multiple applications (607) on each computer system (602). In addition, although illustrated as integral to each computer system (602), in alternative implementations, the application (607) can be external to each computer system (602).

There may be any number of computer systems (602) associated with, or external to, a seismic processing system and a seismic interpretation workstation, wherein each computer system (602) communicates over network (630). Further, the term “client,” “user,” and other appropriate terminology may be used interchangeably as appropriate without departing from the scope of this disclosure. Moreover, this disclosure contemplates that many users may use each computer system (602), or that one user may use multiple computer systems (602).

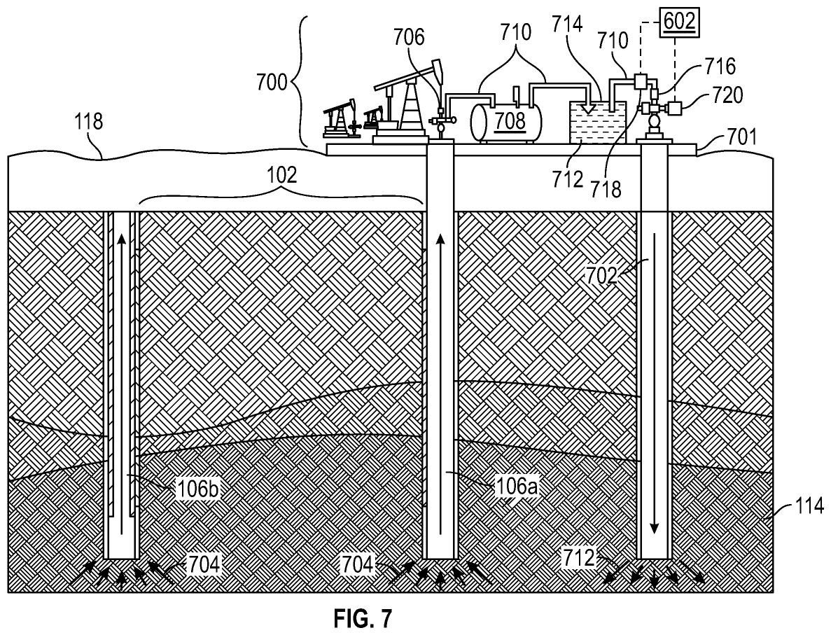

FIG. 7 illustrates a fluid pumping system (700) in accordance with one or more embodiments. The fluid pumping system (700) may lay on a platform (701) above sea waves (118). The fluid pumping system (700) may be used to execute a recovery program, such as a fluid injection program, for the first wellbore (106a) and/or the second wellbore (106b). For illustration, FIG. 7 only shows the fluid pumping system (700) relative to the first wellbore (106a). The recovery program to further produce a hydrocarbon reservoir (114) from the first wellbore (106a) may be based on the subterranean fluid motion in the inter-wellbore region of interest (102) determined from a differential seismic velocity model as previously described in FIG. 5.

An injection wellbore (702) may be drilled within or neighboring the inter-wellbore region of interest (102) to access the hydrocarbon reservoir (114). The production fluids (704) produced by the first wellbore (106a) may be a mixture of hydrocarbons and water. The production fluids (704) may exit the first wellbore (106a) through a production wellhead (706). The production wellhead (706) may be connected to a separator (708) by a pipeline (710). The separator (708) may receive the production fluids (704) and separate the water (712) from the hydrocarbons.

The water (712) may be pumped back into the hydrocarbon reservoir (114) through the injection wellbore (702). Specifically, a pump (not pictured) may pump the water (712) from the separator (708) to the storage tank (714) using a pipeline (710). In other embodiments, the separator (708) and the storage tank (714) may be one and the same. Another pump (not pictured) may pump the water (712) from the storage tank (714) to the injection wellhead (716) using the pipeline (710). The water (712) may be pumped, using the same pump or a different pump, into the injection wellbore (702) and subsequently into the hydrocarbon reservoir (114).

One or more measurement devices may be connected to the injection wellhead (716) to measure injection parameters. A flow rate measurement device (718) and a pressure measurement device (720) may be connected to the injection wellhead (716).

For example, the flow rate measurement device (718) may be connected to the outlet of the pump pumping the water (712) into the injection wellbore (702) and the pressure measurement device (720) may be connected to a wing valve on the injection wellhead (716). The flow rate measurement device (718) may be any type of flow meter known in the art such as an ultrasonic meter, a vortex meter, a turbine meter, etcetera. The pressure measurement device (720) may be any type of pressure gauge known in the art such as an elastic pressure transducer, a bourdon tube pressure gauge, a diaphragm pressure gauge, etcetera.

The pressure measurement device (720), the flow rate measurement device (718), and/or the injection wellhead (716) may be communicably coupled to a computer system (602) as generically described in FIG. 6. The processor (605) of the computer (602) may interact with the injection wellhead (716), the pressure measurement device (720), and/or the flow rate measurement device (718) to collect pressure and flow rate measurements. The pressure and flow rate measurements may be used to further define or alter the recovery program.

In summary, an inter-wellbore region of interest (102) may be monitored, periodically or continuously, during the lifecycle of two or more wellbores (106a, b) using a passive seismic source and optical fibers (124a, b) as seismic receivers. Seismic interferometry and seismic inversion are applied to the seismic dataset for each epoch to determine differential seismic velocity models. The differential seismic velocity models may be used to inform first wellbore (106a) and/or second wellbore (106b) completion and/or recovery programs.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining a first seismic dataset generated by a passive seismic source at a first epoch for an inter-wellbore region of interest lying between a first wellbore and a second wellbore, wherein the first seismic dataset comprises:
a first plurality of seismic traces recorded by a first optical fiber in the first wellbore, and
a second plurality of seismic traces recorded by a second optical fiber in the second wellbore;
determining a first virtual seismic dataset by applying seismic interferometry to the first seismic dataset; and
determining a first seismic velocity model for the inter-wellbore region of interest by applying seismic inversion to the first virtual seismic dataset.

2. The method of claim 1, further comprising:
obtaining a second seismic dataset generated by the passive seismic source at a second epoch for the inter-wellbore region of interest;
determining a second virtual seismic dataset by applying seismic interferometry to the second seismic dataset; and
determining a differential seismic velocity model for the inter-wellbore region of interest by applying seismic inversion to the first virtual seismic dataset and the second virtual seismic dataset.

3. The method of claim 2, further comprising:
determining a subterranean fluid motion based, at least in part, on the differential seismic velocity model.

4. The method of claim 1, further comprising identifying a subterranean feature of interest using the first seismic velocity model.

5. The method of claim 1, wherein the passive seismic source comprises sea waves.

6. The method of claim 1, wherein the inter-wellbore region of interest lies beneath a seabed.

7. The method of claim 1, wherein both the first optical fiber and the second optical fiber are permanently disposed.

8. The method of claim 3, further comprising:
planning a fluid injection program based on the subterranean fluid motion; and
injecting fluid guided by the fluid injection program.

9. The method of claim 1, wherein frequencies of the first seismic dataset comprise a range of 0.1 Hertz to 8.0 Hertz.

10. The method of claim 1, wherein seismic interferometry comprises cross-correlating at least one first seismic trace from the first plurality of seismic traces with at least one second seismic trace from the second plurality of seismic traces.

11. A non-transitory computer-readable memory having computer-executable instructions stored thereon that, when executed by a processor, perform steps comprising:
receiving a first seismic dataset generated by a passive seismic source at a first epoch for an inter-wellbore region of interest lying between a first wellbore and a second wellbore, wherein the first seismic dataset comprises:
a first plurality of seismic traces recorded by a first optical fiber in the first wellbore, and
a second plurality of seismic traces recorded by a second optical fiber in the second wellbore;
determining a first virtual seismic dataset by applying seismic interferometry to the first seismic dataset; and
determining a first seismic velocity model for the inter-wellbore region of interest by applying seismic inversion to the first virtual seismic dataset.

12. The non-transitory computer-readable memory of claim 11, wherein the steps further comprise:
receiving a second seismic dataset generated by the passive seismic source at a second epoch for the inter-wellbore region of interest;
determining a second virtual seismic dataset by applying seismic interferometry to the second seismic dataset; and
determining a differential seismic velocity model for the inter-wellbore region of interest by applying seismic inversion to the first virtual seismic dataset and the second virtual seismic dataset.

13. The non-transitory computer-readable memory of claim 12, wherein the steps further comprise determining a subterranean fluid motion based, at least in part, on the differential seismic velocity model.

14. The non-transitory computer-readable memory of claim 11, wherein the steps further comprise identifying a subterranean feature of interest using the first seismic velocity model.

15. The non-transitory computer-readable memory of claim 11, wherein seismic interferometry comprises cross-correlating at least one first seismic trace from the first plurality of seismic traces with at least one second seismic trace from the first plurality of seismic traces.

16. A system comprising:
a distributed acoustic sensing (DAS) system to record a first seismic dataset for an inter-wellbore region of interest lying between a first wellbore and a second wellbore, wherein the DAS system comprises a first optical fiber in the first wellbore and a second optical fiber in the second wellbore; and
a seismic processing system configured to:
receive the first seismic dataset generated by a passive seismic source at a first epoch, wherein the first seismic dataset comprises:
a first plurality of seismic traces recorded by the first optical fiber; and
a second plurality of seismic traces recorded by the second optical fiber,
determine a first virtual seismic dataset by applying seismic interferometry to the first seismic dataset, and
determine a first seismic velocity model for the inter-wellbore region of interest by applying seismic inversion to the first virtual seismic dataset.

17. The system of claim 16, wherein the seismic processing system is further configured to:
receive a second seismic dataset generated by the passive seismic source at a second epoch for the inter-wellbore region of interest;
determine a second virtual seismic dataset by applying seismic interferometry to the second seismic dataset; and
determine a differential seismic velocity model for the inter-wellbore region of interest by applying seismic inversion to the first virtual seismic dataset and the second virtual seismic dataset.

18. The system of claim 17, further comprising a seismic interpretation workstation configured to determine a subterranean fluid motion based, at least in part, on the differential seismic velocity model.

19. The system of claim 16, further comprising a seismic interpretation workstation configured to identify a subterranean feature of interest using the first seismic velocity model.

20. The system of claim 18, further comprising a fluid pumping system to execute a recovery program based on the subterranean fluid motion.
